(19) United States
(12) Patent Application Publication
(10) Pub. No.: US 2010/0121720 A1
(43) Pub. Date: May 13, 2010

(54) METHOD AND APPARATUS FOR USER GENERATED ADVERTISING

(75) Inventor: David GORODYANSKY, Sunnyvale, CA (US)

Correspondence Address: HAYNES AND BOONE, LLP;IP Section, 2323 Victory Avenue, Suite 700, Dallas, TX, 75219, US

(73) Assignee: ANCHORFREE, INC., Sunnyvale, CA (US)

(21) Appl. No.: 12/552,237

(22) Filed: Sep. 1, 2009

Related U.S. Application Data
(60) Provisional application No. 61/093,685, filed on Sep. 2, 2008.

(51) Int. Cl. G06Q 30/00; G06F 17/30

(52) U.S. Cl. 705/14.64; 707/802; 707/769; 705/14.4; 705/14.49; 707/E17.044; 707/E17.108

(57) ABSTRACT

One embodiment of the inventive concept permits users to generate non-commercial advertisings and place those advertisings for insertion into other content accessed, viewed or requested by other users. In one particular embodiment, the inventive system may be implemented using, for example, ad exchange methodology, which permits free exchange of advertisings between individual users.

### CROSS-REFERENCE TO RELATED APPLICATION

This regular U.S. patent application is based on and claims the benefit of priority under 35 U.S.C. 119 from provisional U.S. patent application No. 61/093,685, filed on Sep. 2, 2008, the entire disclosure of which is incorporated by reference herein.

### FIELD OF THE INVENTION

The present invention relates generally to advertising on the Internet and more specifically to enabling user-generated advertising on the Internet.

### DESCRIPTION OF THE RELATED ART

Several widely used internet portals permit their users to generate private advertisings or listings. For example, users of online auctions can generate descriptions of the merchandise that they offer for sale. Other sites permit users to generate classified-type advertisings for various merchandise or services as well as personal-type advertisings.

However, the existing systems do not allow the individual users to generate advertisings to be inserted into other content owned or posted on the internet by other individual users. Also, the existing systems concentrate on commercial-type advertisings and do not permit users to submit non-commercial advertisings, such as advertisings of the user-generated content. Moreover, the existing systems do not allow users to advertise within a specific geographical location, such as a neighborhood or a city. Finally, the existing systems do no allow users to advertise on wireless networks maintained by other users.

### SUMMARY OF THE INVENTION

The inventive methodology is directed to methods and systems that substantially obviate one or more of the above and other problems associated with conventional techniques for generating advertisings.

In accordance with one aspect of the inventive concept, there is provided a computerized system including a database operable to store parameters of a plurality of user networks; a search module operable to receive information from a user on user's advertising requirements and to match the user advertising requirements with the parameters of at least one of the plurality of user networks; and an ad exchange module, operable to facilitate ad exchange between the user and an owner of the matching at least one of the plurality of user networks.

In accordance with another aspect of the inventive concept, there is provided a system comprising an advertising generating module configured to enable at least one individual user to generate an advertising and an advertising placement module configured to insert the generated advertising into other content owned or posted on an internet by other individual users.

In accordance with yet another aspect of the inventive concept, there is provided a method involving enabling at least one individual user to generate an advertising; and inserting the generated advertising into other content owned or posted on an internet by other individual users.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates a schematic diagram of an exemplary embodiment of the inventive system.

FIG. 2 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

Many users spend substantial amount of time generating their own content for posting on the Internet. For example, a user may produce his or her own video and place it on a video portal or create a custom online profile. In many cases, after investing substantial time and effort in generating such custom content, the user may be willing to pay to advertise the created content to other users.

One embodiment of the inventive concept permits users to generate non-commercial advertisings and place those advertisings for insertion into other content accessed, viewed or requested by other users. In one particular embodiment, the inventive system may be implemented using, for example, ad exchange methodology, which permits free exchange of advertisings between individual users.

It should be noted that modern computer technology allows users to provide advertisings to other users. This can be accomplished, for example, using the DD-WRT technology, well known to persons of skill in the art, which is operable to split a wireless network of a user into two or more portions. In one configuration, one portion of the wireless network is preserved as a private network of the user, for user's own exclusive use. The other portion(s) of the user's network are made available to other users (public portions). In an embodiment of the inventive system, the public network portion is configured to insert advertisements into the content accessed by other user(s) (not the owner of the network) using the aforesaid public portion of the user's wireless network. Thus, the owner of the network may provide advertisings to other users of the network.

The above-described inventive technology allows an individual user to offer other users an advertising-supported free wireless access service. To monetize the available advertising capability, the owner of the wireless network may start selling the advertisings on the public portion of his or her network to other users. In another embodiment of the invention, the user may participate in ad exchange program with another user, whereby the user may place the other user's advertisings on his or her network in exchange for reciprocal placement of the user's ads by the other user. Such ad exchange may be with or without additional payment being made from one user to the other.

To facilitate the aforesaid ad selling and/or ad exchange, an inventive system may include a central or distributed database(s) containing information on advertising capabilities of networks of different individual users. In one embodiment, such a database may include the information on the location of the user's network, the available bandwidth, the network coverage (reception radius), the number of other users that use the particular network during predetermined time period, and other suitable information. The database may also include the statistics of the network usage by other users, as well as network reliability (percentage of down time). In an embodiment of the invention, the database may also include the information on the pricing of the ads that the user requests as well as the information on whether the user-owner of the network is willing to participate in an ad exchange program and the requirements of the user as they relate to the ad exchange.

The inventive system may also include a facility that would enable a particular user to search the content of the aforesaid database and find other users with advertising capabilities that match the user's advertising needs. In one embodiment of the inventive system, the user may locate the other users by searching the aforesaid database and enter into advertising arrangements with other users using an automated facility. To this end, in one embodiment of the invention, the inventive system may facilitate ad exchanges between users by accepting, storing and furnishing advertisings from one party to the other. In the same or another embodiment of the invention, the system has capability to accept payment by one user (ad buyer) and forward it to the other party (ad seller).

Thus, in one embodiment, the inventive system facilitates the creation of a user-to-user advertising network, wherein users may exchange ads with each other or buy ads from each other. In one embodiment of the invention, the advertisings by the users are of non-commercial nature.

In one embodiment of the invention, the inventive ad network is implemented to place user's advertisings on the Internet. In this implementation, the advertisings of other users are placed together with content created by the user on the internet. For example, if a user creates a new video and places it on a video portal, he or she may sell advertising space on a page associated with that content. In another embodiment, the user may place a new and original content on user's own website and sell or exchange advertising space on the page associated with that content.

Such sale or exchange of the content may be with one or more other users. In case of sale/exchange with several other users, the ad of each other user is displayed on the user's page with a predetermined frequency.

One embodiment of the inventive concept is implemented as a free ad exchange in a neighborhood, which makes the displayed advertisings location-specific. In this embodiment, one or more users may utilize the aforesaid DD-WRT technology incorporated into the wireless device to provide advertisings to persons using the wireless network in their neighborhood. Thus, using this embodiment, by participating in the neighborhood ad exchange, a user may advertise any location specific events or other content, such as a party at user's own house. Any other users that would use the wireless services in the neighborhood that are provided by other users participating in the aforesaid ad exchange would be able to see such local advertisements.

It should be noted that the inventive system is not limited to any specific wireless network protocol or router technology, such as DD-WRT technology. Any such suitable technologies may be used.

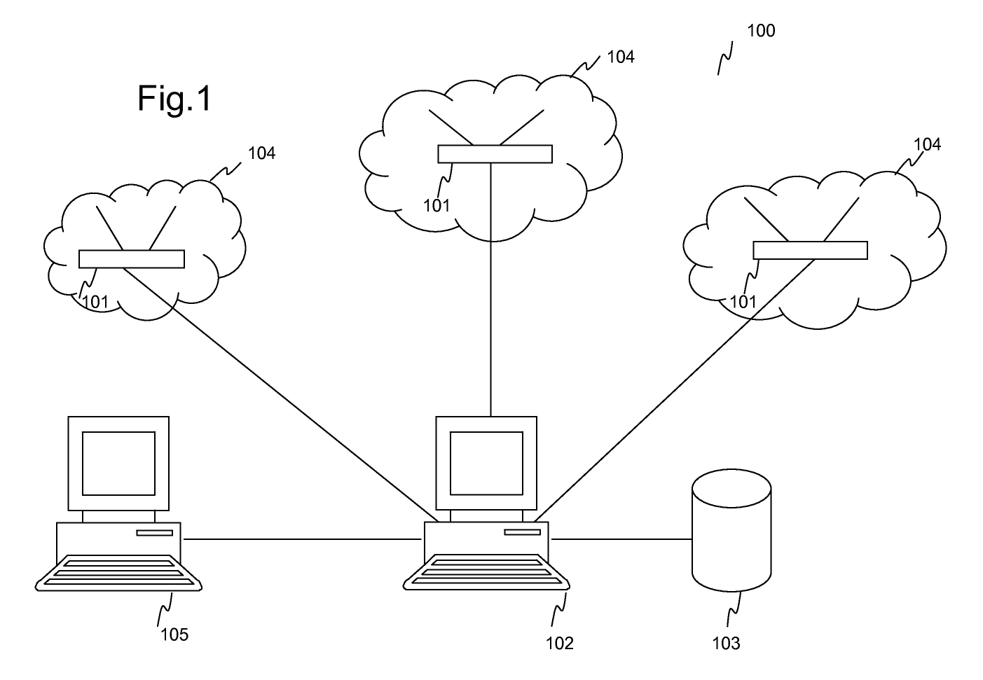

FIG. 1 illustrates a schematic diagram of an exemplary embodiment 100 of the inventive system. The system incorporates one or more wireless routers 101 coupled to a central computer system 102. The routers 101 are configured to enable local wireless networks 104, which may be located in the same or different locations. The routers 101 are also configured to provide advertising capability for owners of the routers 101, such that the users using the networks 104 are shown various advertisings. The central computer system 102 is configured to collect information on advertising capabilities of each router 101, as well as information on the location and other parameters of the router 101 and the associated network 104 and store those parameters in a database 103. The central system 102 is further configured to enable searching the information on the location and advertising capabilities of the routers/networks 101/104 and to enable ad purchases or exchanges between users. For this purpose, a client terminal 105 is provided, using which a user may purchase the advertising or submit advertisings for ad exchange.

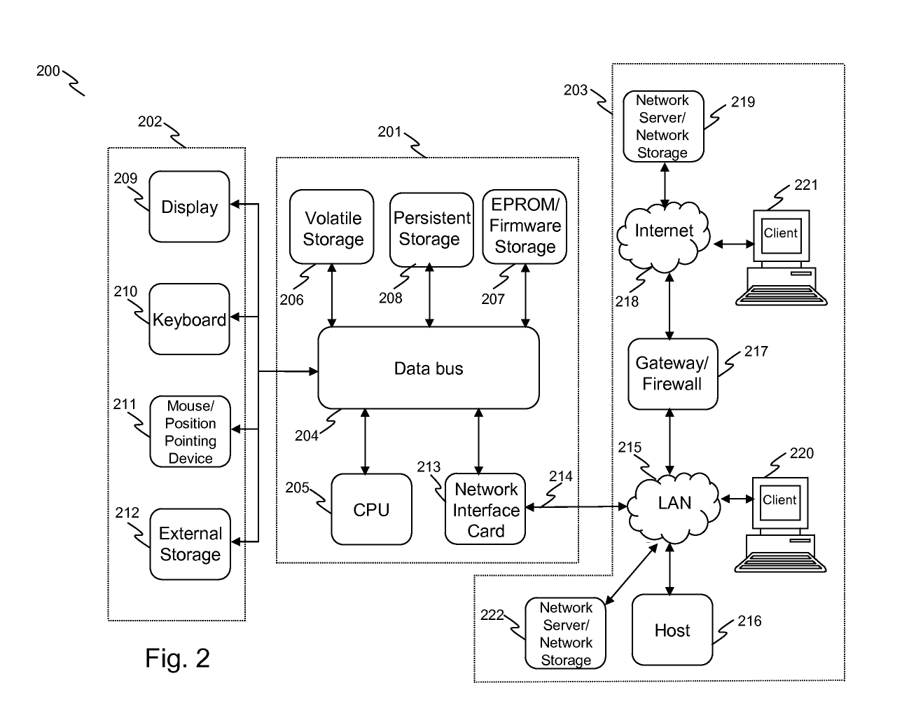

FIG. 2 is a block diagram that illustrates an embodiment of a computer/server system 200 upon which an embodiment of the inventive methodology may be implemented. The system 200 includes a computer/server platform 201, peripheral devices 202 and network resources 203.

The computer platform 201 may include a data bus 204 or other communication mechanism for communicating information across and among various parts of the computer platform 201, and a processor 205 coupled with bus 201 for processing information and performing other computational and control tasks. Computer platform 201 also includes a volatile storage 206, such as a random access memory (RAM) or other dynamic storage device, coupled to bus 204 for storing various information as well as instructions to be executed by processor 205. The volatile storage 206 also may be used for storing temporary variables or other intermediate information during execution of instructions by processor 205. Computer platform 201 may further include a read only memory (ROM or EPROM) 207 or other static storage device coupled to bus 204 for storing static information and instructions for processor 205, such as basic input-output system (BIOS), as well as various system configuration parameters. A persistent storage device 208, such as a magnetic disk, optical disk, or solid-state flash memory device is provided and coupled to bus 201 for storing information and instructions.

Computer platform 201 may be coupled via bus 204 to a display 209, such as a cathode ray tube (CRT), plasma display, or a liquid crystal display (LCD), for displaying information to a system administrator or user of the computer platform 201. An input device 210, including alphanumeric and other keys, is coupled to bus 201 for communicating information and command selections to processor 205. Another type of user input device is cursor control device 211, such as a mouse, a trackball, or cursor direction keys for communicating direction information and command selections to processor 204 and for controlling cursor movement on display 209. This input device typically has two degrees of freedom in two axes, a first axis (e.g., x) and a second axis (e.g., y), that allows the device to specify positions in a plane.

An external storage device 212 may be connected to the computer platform 201 via bus 204 to provide an extra or removable storage capacity for the computer platform 201. In an embodiment of the computer system 200, the external removable storage device 212 may be used to facilitate exchange of data with other computer systems.

The invention is related to the use of computer system 200 for implementing the techniques described herein. In an embodiment, the inventive server 103 may reside on a machine such as computer platform 201. In an embodiment, the location database 204 may also be deployed on a machine such as computer platform 201. According to one embodiment of the invention, the techniques described herein are performed by computer system 200 in response to processor 205 executing one or more sequences of one or more instructions contained in the volatile memory 206. Such instructions may be read into volatile memory 206 from another computer-readable medium, such as persistent storage device 208. Execution of the sequences of instructions contained in the volatile memory 206 causes processor 205 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 205 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 208. Volatile media includes dynamic memory, such as volatile storage 206. Transmission media includes coaxial cables, copper wire and fiber optics, including the wires that comprise data bus 204.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 205 for execution. For example, the instructions may initially be carried on a magnetic disk from a remote computer. Alternatively, a remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on the data bus 204. The bus 204 carries the data to the volatile storage 206, from which processor 205 retrieves and executes the instructions. The instructions received by the volatile memory 206 may optionally be stored on persistent storage device 208 either before or after execution by processor 205. The instructions may also be downloaded into the computer platform 201 via Internet using a variety of network data communication protocols well known in the art.

The computer platform 201 also includes a communication interface, such as network interface card 213 coupled to the data bus 204. Communication interface 213 provides a two-way data communication coupling to a network link 214 that is connected to a local network 215. For example, communication interface 213 may be an integrated services digital network (ISDN) card or a modem to provide a data communication connection to a corresponding type of telephone line. As another example, communication interface 213 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 213 sends and receives electrical, electromagnetic or optical signals that carry digital data streams representing various types of information.

Network link 213 typically provides data communication through one or more networks to other network resources. For example, network link 214 may provide a connection through local network 215 to a host computer 216, or a network storage/server 217. Additionally or alternatively, the network link 213 may connect through gateway/firewall 217 to the wide-area or global network 218, such as an Internet. Thus, the computer platform 201 can access network resources located anywhere on the Internet 218, such as a remote network storage/server 219. On the other hand, the computer platform 201 may also be accessed by clients located anywhere on the local area network 215 and/or the Internet 218. The network clients 220 and 221 may themselves be implemented based on the computer platform similar to the platform 201.

Local network 215 and the Internet 218 both use electrical, electromagnetic or optical signals that carry digital data streams. The signals through the various networks and the signals on network link 214 and through communication interface 213, which carry the digital data to and from computer platform 201, are exemplary forms of carrier waves transporting the information.

Computer platform 201 can send messages and receive data, including program code, through the variety of network(s) including Internet 218 and LAN 215, network link 214 and communication interface 213. In the Internet example, when the system 201 acts as a network server, it might transmit a requested code or data for an application program running on client(s) 220 and/or 221 through Internet 218, gateway/firewall 217, local area network 215 and communication interface 213. Similarly, it may receive code from other network resources.

The received code may be executed by processor 205 as it is received, and/or stored in persistent or volatile storage devices 208 and 206, respectively, or other non-volatile storage for later execution. In this manner, computer system 201 may obtain application code in the form of a carrier wave.

It should be noted that the present invention is not limited to any specific types of wireless or wired network protocols. The requisite network configuration may be achieved using a variety of known networking protocols.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized system for user-generated non-commercial advertisings. It is intended that the specification and examples be considered as exemplary only, with a true scope and spirit of the invention being indicated by the following claims.

What is claimed is:

1. A system comprising:
an advertising generating module operable to enable at least one individual user to generate an advertising; and
an advertising placement module operable to insert the generated advertising into other content owned or posted by other individual users.

2. The system of claim 1, wherein the generated advertising is non-commercial.

3. The system of claim 1, wherein the generated advertising is directed to content created by the individual users.

4. The system of claim 1, wherein the advertising placement module is operable to insert the generated advertising only within a specific geographical location.

5. The system of claim 1, wherein the advertising placement module is operable to insert the generated advertising into at least one wireless network operated by at least one of the other individual users.

6. The system of claim 1, wherein the wireless network is split into a private portion of the at least one of the other individual users and a public portion, the public portion operable to provide the advertising to subscribers.

7. The system of claim 5, wherein the system further comprises a payment module operable to process a payment from the at least one individual user generating the advertising to the at least one of the other individual users maintaining the wireless network.

8. The system of claim 5, wherein the generated advertising is placed on the wireless network of the at least one of the other individual users in exchange for a second advertising generated by the at least one of the other individual users being placed on a second wireless network maintained by the at least one individual user.

9. The system of claim 5, wherein the system further comprises a database operable to store parameters of the at least one wireless network.

10. The computerized system of claim 9, wherein the parameters comprise a location of the at least one wireless network.

11. The computerized system of claim 9, wherein the parameters comprise the coverage of the at least one wireless network.

12. The computerized system of claim 9, wherein the parameters comprise the usage information of the at least one wireless network.

13. The computerized system of claim 9, further comprising a search module operable to enable a user to search the database for a wireless network with parameters required by the user.

14. The computerized system of claim 13, wherein the system is operable to enable the user to perform an automatic advertising exchange with the other user maintaining the wireless network with parameters required by the user.

15. A computerized system comprising:
a database operable to store parameters of a plurality of user networks;
a search module operable to receive information from a user on user's advertising requirements and to match the user advertising requirements with the parameters of at least one of the plurality of user networks; and
an ad exchange module, operable to facilitate ad exchange between the user and an owner of the matching at least one of the plurality of user networks.

16. The computerized system of claim 1, wherein the parameters comprise the locations of the user networks.

17. The computerized system of claim 1, wherein the parameters comprise the coverage of the user networks.

18. The computerized system of claim 1, wherein the parameters comprise the usage information of the user networks.

19. A method comprising:
enabling at least one individual user to generate an advertising; and
inserting the generated advertising into other content owned or posted by other individual users.

20. The method of claim 19, wherein the generated advertising is non-commercial.

21. The method of claim 19, wherein the generated advertising is directed to content created by the individual users.

22. The method of claim 19, wherein inserting is performed only within a specific geographical location.

23. The method of claim 19, wherein the advertising placement module is operable to insert the generated advertising into at least one wireless network operated by at least one of the other individual users.

24. The method of claim 23, wherein the wireless network is split into a private portion of the at least one of the other individual users and a public portion, the public portion operable to provide the advertising to subscribers.

25. The method of claim 23, further comprising processing a payment from the at least one individual user generating the advertising to the at least one of the other individual users maintaining the wireless network.

26. The method of claim 23, wherein the generated advertising is placed on the wireless network of the at least one of the other individual users in exchange for a second advertising generated by the at least one of the other individual users being placed on a second wireless network maintained by the at least one individual user.

27. The method of claim 23, further comprising storing in a database parameters of the at least one wireless network.

28. The method of claim 27, wherein the parameters comprise a location of the at least one wireless network.

29. The method of claim 27, wherein the parameters comprise the coverage of the at least one wireless network.

30. The method of claim 27, wherein the parameters comprise the usage information of the at least one wireless network.

31. The method of claim 27, further comprising enabling a user to search the database for a wireless network with parameters required by the user.

32. The method of claim 31, further comprising enabling the user to perform an automatic advertising exchange with the other user maintaining the wireless network with parameters required by the user.
